(19) United States
(12) Patent Application Publication
(10) Pub. No.: US 2023/0280640 A1
(43) Pub. Date: Sep. 7, 2023

(54) Connector for Connecting a Cell Phone to an Optical Instrument and Use of such a Connector

(71) Applicant: SIGHTS OF NATURE BV, Jabbeke (BE)

(72) Inventor: Wim Boudewyns, Wijnegem (BE)

(73) Assignee: SIGHTS OF NATURE BV, Jabbeke (BE)

(21) Appl. No.: 18/161,262

(22) Filed: Jan. 30, 2023

(30) Foreign Application Priority Data
Mar. 1, 2022 (BE) 2022/5145

(51) Int. Cl. G03B 17/56

(52) U.S. Cl. CPC G03B 17/566; G03B 17/565; G03B 17/48

(57) ABSTRACT

A connector for connecting a cell phone to an optical instrument, wherein the connector comprises a first part, a second part and a third part, wherein the first part is provided with first means for connecting the first part to the optical instrument, wherein the second part is connected slidably and rotatably to the first part, wherein the connector is provided with second means for releasably fastening the second part relative to the first part, wherein the third part is made of a ferromagnetic material and is arranged to be connected to a cell phone, wherein the second part is provided with one or more magnets for magnetically connecting the third part to the second part.

### CROSS-REFERENCES TO RELATED APPLICATIONS

This Non-Provisional Utility Application claims the benefit of and priority to Belgium Patent Application Serial No. BE2022/5145, filed Mar. 1, 2022, entitled “Connector for Connecting a Cell Phone to an Optical Instrument and Use of such a Connector,” the entire contents of which is hereby incorporated herein by reference.

### BACKGROUND

The invention concerns a connector for connecting a cell phone to an optical instrument and the use of such a connector.

Users of optical instruments wish to use the camera of their cell phone for filming or photographing the image they observe through the optical instrument. This concerns in particular, but not only, observation of nature by means of the optical instrument.

Several types of connectors are known for this purpose. These are however often intended for a certain brand, type or size of optical instrument and therefore not usable universally.

Also, connecting the cell phone to the connector is not evident, because the cell phone needs to be clamped in a holder and positioned correctly in that holder in order to align the camera lens with the ocular lens of the optical instrument. This alignment needs to be done very accurately.

This results, in practice, in an inability to connect and disconnect the cell phone easily and quickly.

In addition, obviously the cell phone will then be positioned in front of the ocular lens, so the optical instrument is then temporarily not available for a person to observe the image directly. Resulting from this, a rapid and repeated alternation between use of the optical instrument with and without the cell phone is not possible with the known connectors. Also, rapid and repeated alternation between use of the cell phone connected to the optical instrument and not connected to the optical instrument is not possible.

### SUMMARY

The present invention aims to solve these and other problems and concerns a connector for connecting a cell phone which is provided with a camera to an optical instrument, wherein the connector comprises a first part and a second part, wherein the first part is provided with first means for connecting the first part to the optical instrument, wherein the second part is connected slidably and rotatably to the first part, wherein the connector is provided with second means for releasably fastening the second part relative to the first part, wherein the connector comprises a third part, wherein the third part is made of a ferromagnetic material, wherein the third part is arranged to be connected to a cell phone, wherein the second part is provided with one or more magnets for magnetically connecting the third part to the second part.

Due to this connector, in particular due to the magnetic connection of the third part, which during use of the connector is connected to the cell phone, to the second part, the cell phone can be quickly and easily removed from the optical instrument, so the cell phone and/or the optical instrument can be used separately, and can also be quickly and easily reconnected to the optical instrument connector if desired.

Preferably, during use of the connector, the third part is connected directly to the cell phone or indirectly connected to the cell phone, by means of cover in which the cell phone is held.

Due to the movability and the connectability of the first part and second part relative to each other, a correct alignment of the camera lens with the ocular lens can be obtained independently of the connection of the third part, and therefore of the cell phone, to the second part. This correct alignment can, as a result, also be maintained when removing the cell phone from the optical instrument and reconnecting the cell phone to the optical instrument.

In a preferred embodiment the optical element is a pair of binoculars, a telescope or a microscope.

In a preferred embodiment the second part is provided with a recess which is complementary to the shape and size of the third part, so the recess can receive the third part fittingly. This achieves that the connection is more stable and that the mutual orientation is the same every time.

In a preferred embodiment the recess in the second part is bounded by a bottom wall and one or more side walls, wherein the one or more magnets are located in the bottom wall. The one or more side walls thereby ensure the stable connection and the reproducibility of the relative orientation, whereas the magnets effect the connection in a direction which is largely or completely perpendicular to the normal direction to the side walls so they can exercise a maximum attractive force.

In a preferred embodiment, in a state in which the third part is positioned in the recess, a part of a side wall is located at a greater distance from the third part than other parts of the side walls, wherein said greater distance is at least 1.5 mm.

Because of this greater distance there is space, in case the third part is positioned in the recess and especially without the third part being connected to a cell phone, for inserting a tool, eg. a screw driver or a pocket knife, between the side walls and the third part for easier removal of the third part from the recess, against the magnetic force.

In a preferred embodiment the third part is plate--shaped, wherein the third part has a thickness, wherein the recess has a depth that corresponds to said thickness of the third part.

As a result the third part fits exactly in the recess, leading to a stronger connection and avoiding an unnecessarily large third part.

In a preferred embodiment the third part is plate-shaped and has a thickness of 6 mm or less, preferably a thickness of 4 mm or less, and more preferably a thickness of 3 mm or less. Consequently, the third part is thin, so it interferes minimally or not at all with use of the cell phone during periods that the cell phone not is connected to the optical instrument.

In a preferred embodiment the third part is arranged to be connected to a cell phone, meaning directly or to a cover in which the cell phone is held, by the third part being provided with an adhesive layer.

In a preferred embodiment the first part and/or the second part is/are provided with a layer of rubber on a mutual contact surface in order to increase friction between the first part and the second part.

Due to this the second means need to exercise a smaller force than without such a layer of rubber to ensure that the first part and the second part are fixed relative to each other.

In a preferred embodiment the first means comprise a belt which forms a closed loop together with the first part and which can be slid around an eyepiece of the optical instrument and comprise a tightening mechanism for tightening the belt by making the loop smaller.

This enables the connector to be connected quickly and easily to different optical instruments having eyepieces of different sizes.

This also allows the user to freely choose the position of the connector around the ocular lens, so both left-handed persons as well as right-handed persons can select a position which is most comfortable to them.

In a preferred embodiment the belt is a toothed belt, wherein the teeth of the toothed belt are located at the inner side of the loop. Consequently the belt is less likely to inadvertently shift around the optical instrument, so the connector is better attached.

In a preferred embodiment the toothed belt has two extremities, wherein the tightening mechanism comprises a carriage which is part of the first part and which is movable relative to the rest of the first part by means of an axle which is provided with an external thread and which is rotatable in an internal thread in the carriage, wherein the extremities of the toothed belt are held in the carriage by form fitting. Herein, the axle has a fixed position relative to the rest of the first part.

This has the advantage that another toothed belt can easily be installed. Due to this, toothed belts with very different lengths can easily be used, so the first part can be connected to optical instruments with very different dimensions.

The invention further concerns the use of a connector according to the invention for connecting a cell phone which is provided with a camera to an optical instrument, wherein the optical instrument is a pair of binoculars or a telescope or a microscope, wherein the optical instrument has an eyepiece and an ocular lens, wherein the first part is connected to the eyepiece of the optical instrument.

### BRIEF DESCRIPTION OF THE DRAWINGS

In order to clarify the invention a preferred embodiment of a connector according to the invention is described below, with reference to the following figures, wherein:

FIGS. 1 to 3 represent mutually different perspective views of a connector according to the invention;

FIG. 4 represents a cross section according to IV-IV of parts of the connector of FIGS. 1 to 3, as explained below;

FIG. 5 represents the connector of FIGS. 1 to 3 in a perspective view as in FIG. 1 with a number of parts of the connector separate from each other;

FIG. 6 represents the connector of FIGS. 1 to 3 in a perspective view with all parts of the connector separate from each other;

FIG. 7 represents a view according to F7 of the connector of FIGS. 1 to 3 with a part removed;

FIGS. 8 to 10 represent the use of the connector of FIGS. 1 to 3;

FIG. 11 represents a side view of a component of the connector as indicated by F11 in FIG. 5.

### DETAILED DESCRIPTION

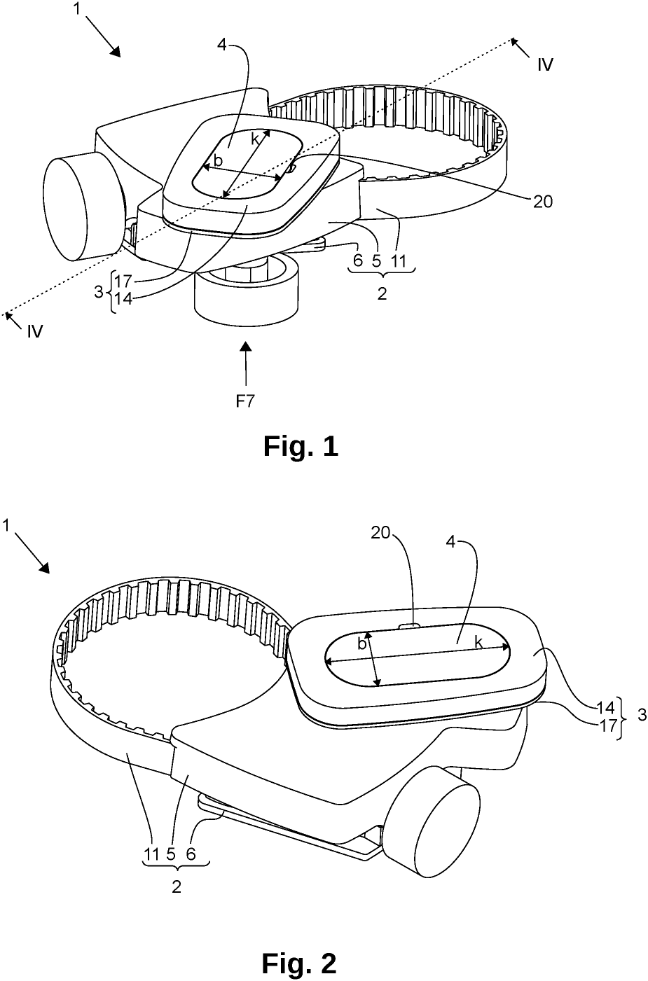

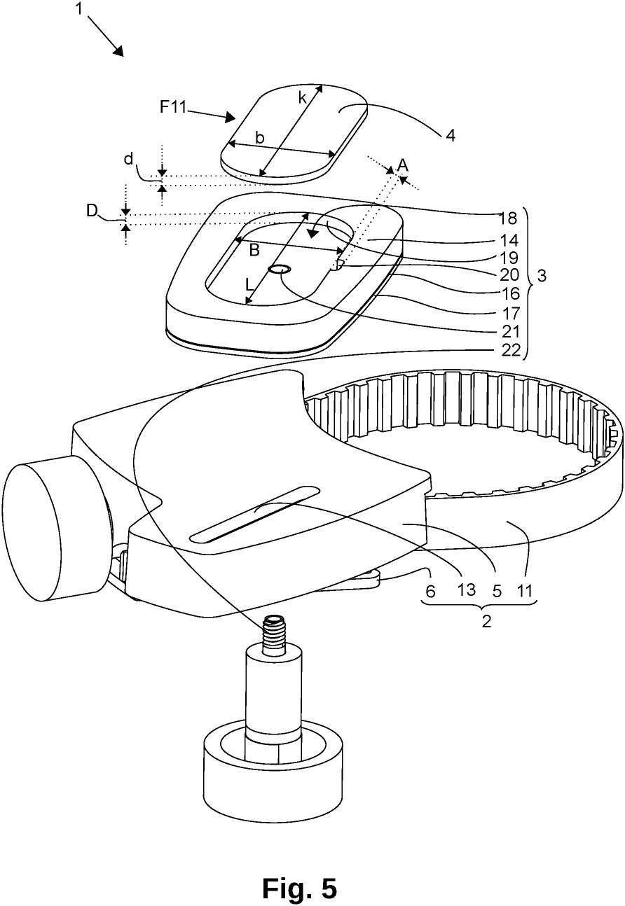

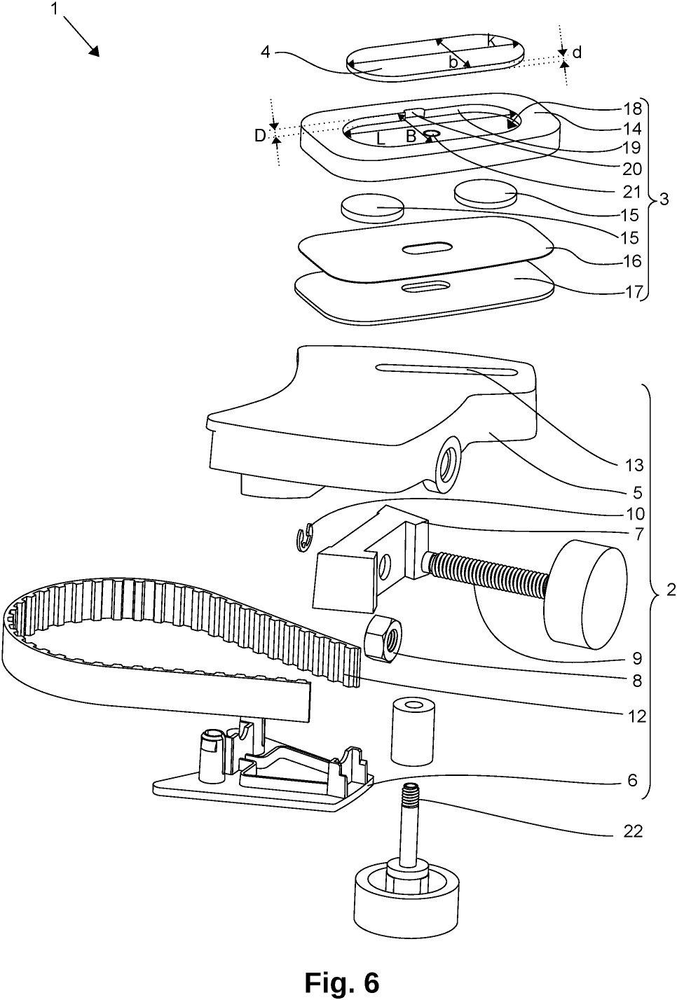

The connector 1 of FIGS. 1 to 6 consists of three main components, which are most easily seen FIG. 5, in particular a first part 2, a second part 3 and a third part 4.

The first part 2 is intended and arranged for connecting it to an optical instrument and comprises a first housing 5 with a cover lid 6, in which a plastic carriage 7 is movably installed. In this example the first housing 5 is made of aluminum.

The carriage 7 is provided internally with a nut 8 having an internal thread. The first part 2 is further provided with a first axle 9 which is provided with an external thread and a knob. The first axle 9 is held in a fixed position in the first housing 5 by a circlip 10 and is arranged in the nut 8, so, by rotating the first axle 9, the carriage 7 is movable inside the first housing 5.

The first part 2 further comprises a toothed belt 11 of which the extremities are attached to the carriage 7 in such way that a loop is formed, with the teeth of the toothed belt 11 being directed to the inner side of the loop. For this purpose the carriage 7 is provided with two first recesses 12 having a shape which is complementary to the shape of the teeth of the toothed belt 11 and in which the extremities of the toothed belt 11 are placed, after which the first housing 5 is closed with the cover lid 6 to avoid that the extremities of the toothed belt 11 might slide out of their first recesses 12. The toothed belt 11 and the first housing 5 together form a closed loop.

The first part 2 is provided with a slotted hole 13.

The second part 3 comprises a second housing 14, in which two disk-shaped magnets 15 are installed in cavities provided for that purpose. These cavities are closed by a piece of adhesive tape 16 which is applied against the second housing 14. The second housing 14 is also made of aluminum. The second part 3 is provided on its underside with a layer of NBR-rubber 17.

On its upper side the second housing 14 is provided with a second recess 18, wherein the second housing 14 forms the bottom wall and side walls 19 of the second recess 18. The second recess 18 has a depth D of 2.0 mm, a width H of 20 mm and a length L of 45 mm. On a small part a side walls 19 of the second recess 18 recedes over a distance of 2.0 mm so an auxiliary recess 20 is formed. A central hole 21 which is provided with an internal thread is provided in the second housing 14.

The second part 3 further comprises a second axle 22 with a knob and with an extremity that is provided with an external thread. The second axle 22 runs through the slotted hole 13 and the extremity of the second axle 22 is screwed into the central hole 21 of the second housing 14.

By loosening the second axle 22 the second part 3 may be slid and rotated relative to the first part 2, and by tightening the second axle 22 the first part 2 and the second part 3 are pulled against each other so they become fixed relative to each other. The layer of NBR-rubber 17 contributes to this by increasing friction between the first part 2 and the second part 3, so these can be fixed better, relative to each other.

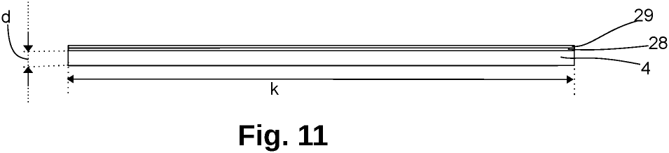

The third part 4 consists of an elongated steel plate made of ferritic steel onto which an adhesive layer 28 is applied which is covered by a cover sheet 29.For completeness it is noted that the adhesive layer and the cover sheet are not represented in FIGS. 1 to 10 but are represented in FIG. 11. The steel plate has a thickness d of 2 mm, a width b of 20 mm and a length k of 45 mm, so the steel plate fits exactly in the second recess 18.

The distance over which the carriage 7 can move in the first housing 5 is relatively limited. Consequently the connector 1 as represented in FIGS. 1 to 7 is suitable for use with only a limited range of diameters of the eyepiece of the telescope. This can however easily be adapted by taking an adapted length of the toothed belt 11. The toothed belt 11 which is already installed can be easily removed by removing the cover lid 6 and removing the extremities of the toothed belt 11 from the first recesses 12. Subsequently a toothed belt 11 with a different length can be installed on the carriage 7, so the connector 1 becomes usable with a thicker or thinner eyepiece of a telescope.

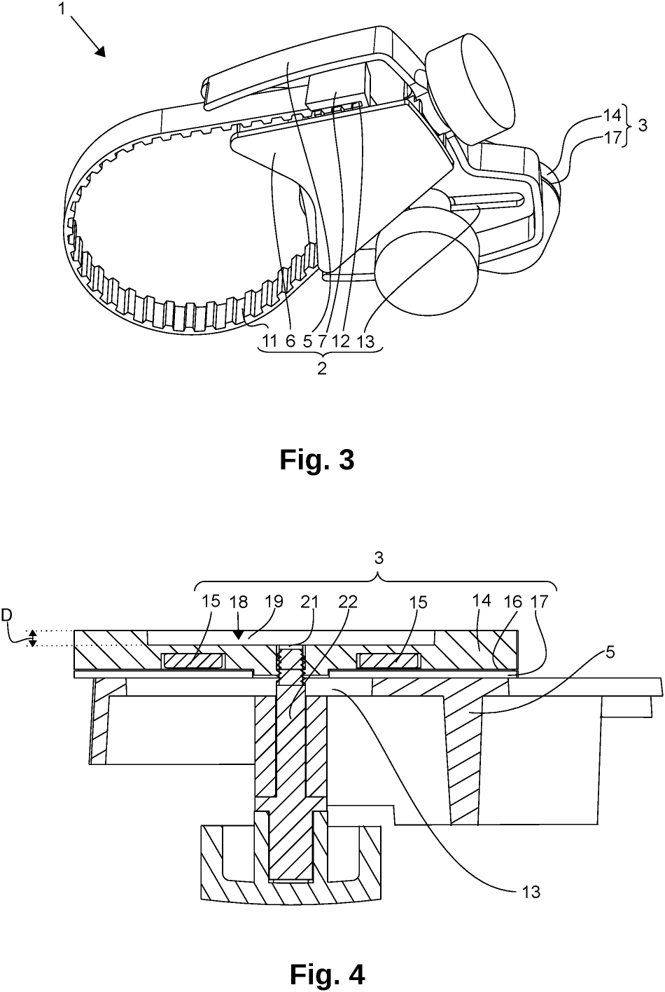

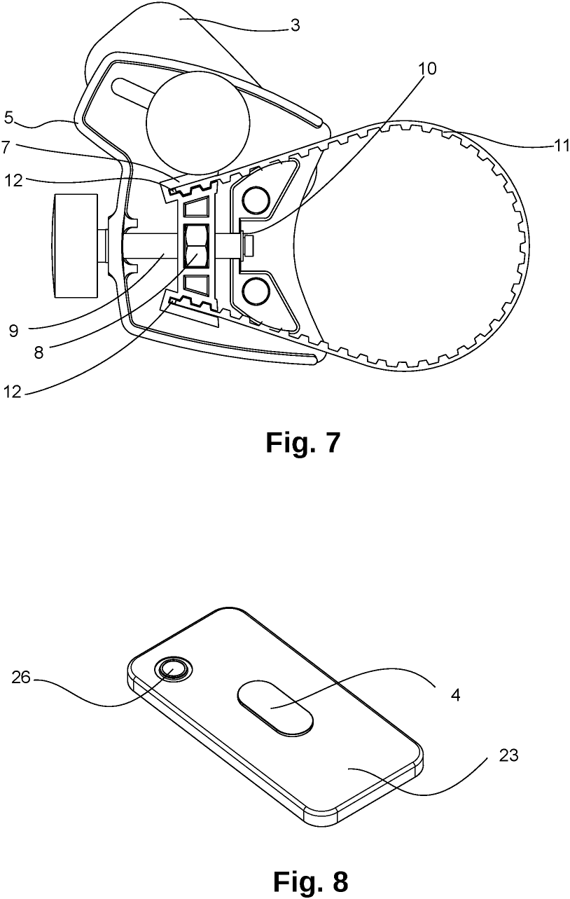

The cross-section of FIG. 4 is mainly intended for illustrating the joint operation of the second part 3 and the first housing 5. The other parts are therefore not visible in FIG. 4. In the view according to FIG. 7 the cover lid 6 has been removed.

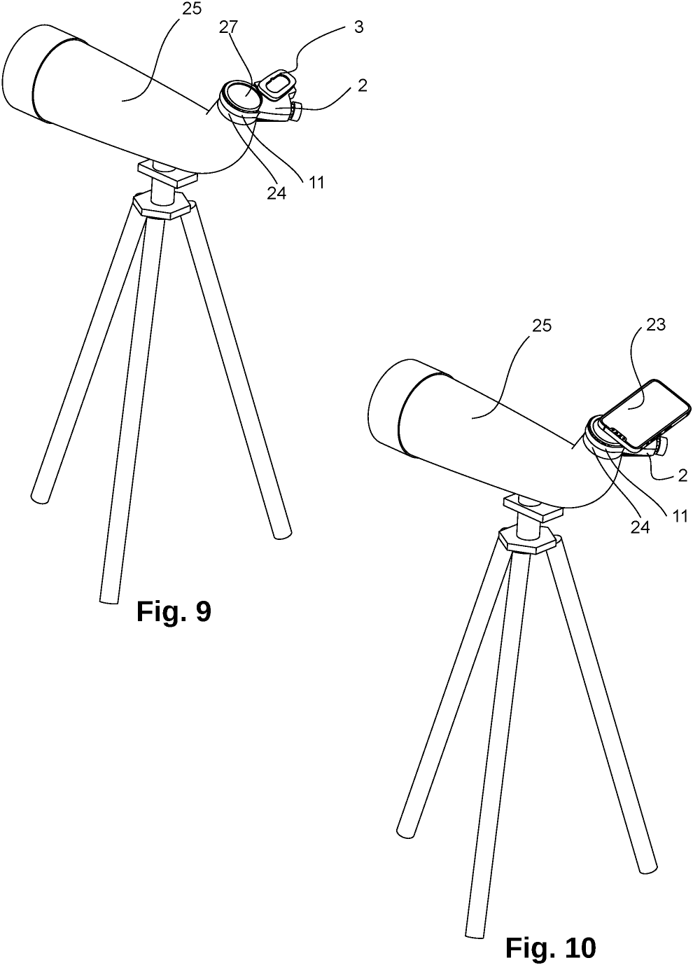

The use of the connector 1 is described below, with reference to FIGS. 8 to 10.

First, the third part 4 is adhered to the back of a cell phone 23 by means of the adhesive layer on the third part 4. This can be done to the cell phone 23 itself or to a standard rubber or plastic protective cover which is adapted to the dimensions of the cell phone 23 and in which the phone is placed. In case the third part 4 is positioned in the second recess 18 before the third part 4 is adhered to the cell phone 23, the third part 4 may be easily removed from the second recess 18 by means of a small tool, for example a screw driver or a pocket knife, by placing it in the auxiliary recess 20 and pushing the third part 4 up, out of the second recess 18.

Subsequently the closed loop, formed by the toothed belt 11 and the first housing 5, is slid around the eyepiece 24 of a telescope 25. By rotating the first axle 9, the carriage 7 is now moved inside the first housing 5 so the closed loop becomes smaller and the first part 2 is clamped around the eyepiece 24. The user can choose a desired position of the first part 2 around the eyepiece 24. This situation is represented in FIG. 9.

Subsequently the third part 4, to which the cell phone 23 is connected, is placed in the second recess 18. By the magnetic force applied on the third part 4 by the magnets 15, the third part 4 is held firmly in the second recess 18. The cell phone 23 is now connected to the telescope 25.

Before the camera of the cell phone 23 can be used in practice, the camera lens 26 of that camera must be aligned with the ocular lens 27 of the telescope 25.

By loosening the second axle 22 slightly, the second part 3 of the connector 1, and therefore also the cell phone 23, is movable relative to the ocular lens 27, both linearly in the direction in which the slotted hole 13 extends as well as by means of rotation around the second axle 22. Consequently a correct alignment of the camera lens 26 with the ocular lens 27 can be obtained easily, after which the second axle 22 is tightened again so the second part 3 is fixed relative to the first part 2.

The cell phone 23 is now correctly connected to the telescope 25, as represented in FIG. 10.

The cell phone 23 and the telescope 25 may now be used separately or jointly, as desired, because the cell phone 23 and the adhered third part 4 can be taken off the rest of the rest of the connector 1 easily, as represented in FIG. 9, and subsequently also be replaced easily, wherein the correct position of the camera lens 26 relative to the ocular lens 27 is maintained.

1. A connector for connecting a cell phone to an optical instrument, wherein the connector comprises a first part and a second part, wherein the first part is provided with first means for connecting the first part to the optical instrument, wherein the second part is connected slidably and rotatably to the first part, wherein the connector is provided with second means for releasably fastening the second part relative to the first part, wherein the connector comprises a third part, wherein the third part is made of a ferromagnetic material, wherein the second part is provided with one or more magnets for magnetically connecting the third part to the second part.

2. The connector of claim 1, wherein the second part is provided with a recess which is complementary to the shape and size of the third part, in such a way that the third part fits in the recess.

3. The connector of claim 2, wherein the recess is bounded by a bottom wall and one or more side walls, wherein the one or more magnets are located in the bottom wall.

4. The connector of claim 2, wherein the recess is bounded by a bottom wall and one or more side walls, wherein, in a state in which the third part is positioned in the recess, a part of the side walls is located at a greater distance (A) from the third part than other parts of the side walls, wherein said greater distance (A) is at least 1.0 mm.

5. The connector of claim 2, wherein the third part is plate-shaped and has a thickness (d), wherein the recess has a depth (D) which corresponds to said thickness (d) of the third part.

6. The connector of claim 1, wherein the third part is plate-shaped and has a thickness (d) of 6 mm or less.

7. The connector of claim 1, wherein the third part is arranged to be connected to a cell phone.

8. The connector of claim 7, wherein the third part is arranged to be connected to a cell phone by means of the third part being provided with an adhesive layer.

9. The connector of claim 1, wherein the first part and/or the second part is/are provided with layer of rubber on a mutual contact surface.

10. The connector of claim 1, wherein the first means comprise a belt which, together with the first part, forms a closed loop which can be slid around an eyepiece of the optical instrument and comprise a tightening mechanism for tightening the belt by making the loop smaller.

11. The connector of claim 10, wherein the belt is a toothed belt, wherein the teeth of the toothed belt are located at the inner side of the loop.

12. The connector of claim 11, wherein the toothed belt has two extremities, wherein the tightening mechanism comprises a carriage which is part of the first part and which is movable relative to the rest of the first part by means of an axle which is provided with an external thread, wherein the external thread is received in an internal thread in the carriage, wherein the extremities of the toothed belt are held in the carriage by form fitting.

13. The connector of claim 1, further comprising a cell phone, wherein the third part is connected, directly or via a cell phone cover, to the cell phone.

14. A method for connecting a cell phone which is provided with a camera to an optical instrument, wherein the optical instrument is a pair of binoculars or a telescope or a microscope, wherein the optical instrument has an eyepiece and an ocular lens, wherein the method makes use of a connector,
wherein the connector comprises a first part and a second part, wherein the first part is provided with first means for connecting the first part to the optical instrument, wherein the second part is connected slidably and rotatably to the first part, wherein the connector is provided with second means for releasably fastening the second part relative to the first part, wherein the connector comprises a third part, wherein the third part is made of a ferromagnetic material, wherein the second part is provided with one or more magnets for magnetically connecting the third part to the second part, and
wherein the first part is connected to the eyepiece of the optical instrument.

15. The method of claim 14, wherein the third part is connected, directly or via a cell phone cover, to the cell phone, wherein the cell phone is connected magnetically to the second part by means of the third part.

16. The method of claim 14, wherein the method includes aligning a camera lens of the cell phone with the ocular lens of the optical instrument, wherein the relative position and orientation of the first part and the second part are adjusted until the camera lens is aligned with the ocular lens, after which the second part is fastened relative to the first part by means of the second means.
